(19) United States
(12) Patent Application Publication
(10) Pub. No.: US 2013/0097018 A1
(43) Pub. Date: Apr. 18, 2013

(54) METHODS FOR AND APPARATUS FOR PROVIDING ASSISTANCE TO A PURCHASER

(71) Applicants: Robert Davidson, New York, NY (US); Fanny Chung Davidson, New York, NY (US); Belinda Womack, Sante Fe, NM (US)

(72) Inventors: Robert Davidson, New York, NY (US); Fanny Chung Davidson, New York, NY (US); Belinda Womack, Sante Fe, NM (US)

(21) Appl. No.: 13/607,745

(22) Filed: Sep. 9, 2012

Related U.S. Application Data
(60) Provisional application No. 61/547,018, filed on Oct. 13, 2011.

(51) Int. Cl. G06Q 30/02

(52) U.S. Cl. 705/14.53; 705/26.7

(57) ABSTRACT

The present invention provides methods and apparatus for assisting a Purchaser in making a decision related to a Purchase. The decision may include which Product or Service will most satisfy a Purchaser in the event that the Purchaser acquires the Product or Service. The assistance is based upon emotional motivators associated with the Purchaser.

### CROSS REFERENCE TO RELATED APPLICATIONS

The present application claims priority to provisional patent application Ser. No. 61/547018, filed, Oct. 13, 2011 and entitled, “Methods and Apparatus for Providing Assistance to a Purchaser”, the contents of which are relied upon and incorporated by reference.

### FIELD OF THE INVENTION

The present invention relates to methods and apparatus for assessing emotional motivators and recommending a product or service based upon a match of the user's emotional motivators to one or more characteristics of a product or service. More specifically, the present invention includes computerized apparatus logically connected and programmed to assess a user's emotional motivators and match a quality of one or both of a product or service with the user's emotional motivators.

### BACKGROUND OF THE INVENTION

In today's world, a Purchaser may often find it beneficial to receive assistance in making a decision as to which Product or Service the Purchaser should select. A sheer number of choices presented by a number of products available and a number of vendors and venues, both online and brick and mortar, may be overwhelming. Decision making may be further complicated by time constraints faced by a user. Time pressures to make a decision on which Product or Service to purchase make it difficult for a Purchaser to conduct detailed research into various Products available. As a result, Purchaser is often forced into a decision to Purchase with little understanding about whether the Purchase will prove satisfactory to the Purchaser.

Advertisement may be helpful, but does not fully remedy the problem since advertising is almost as much art as it is science. Advertising agencies attempt to ascertain what will appeal to the masses and then position products in a light which it guesses will sell those products. Demographic data is collected and reviewed to study which products appeal to various demographic groups, and advertisement media may be tailored to reach those demographic groups.

Online sales have allowed advertising to evolve and online sellers may now suggest additional products to a user for the user to purchase based upon a purchasing history of the user. The advertising agency and seller may have other data sources to quantify user demand which the advertiser and seller may analyze and study to better position themselves with respect to segments of society that may purchase their goods.

However, there has not existed a tool which allows a user who is a potential purchaser to process data on various available products and equate those products on a personal basis in order to ascertain which Products will prove to be satisfactory to the Purchaser.

### SUMMARY OF THE INVENTION

Accordingly, the present invention provides a Purchaser with methods and apparatus for providing guidance relating to a purchase, a life event or other decision which may involve emotional motivators. The essence of the present invention includes providing an automated system indicating an appropriateness of a purchase according to which Products or Services are most likely to satisfy one or more emotional motivations specifically related with a user. Options which satisfy emotional motivators of a user, such as a Purchaser, are based upon an interactive assessment of the user's emotional state. In some embodiments, the interactive assessment may be provided online and thereby become widely available for use by a Purchaser.

In another related aspect, the present invention receives input data that is descriptive of one or more Products or Services, and associates emotional qualifiers to Products and Services. Emotional qualifiers represent which emotional motivators may be met by a particular Product or Service. In some preferred embodiments, emotional qualifiers are associated with “hard” dictionary classifications and “soft” dictionary classifications.

A related aspect of the present invention provides methods and apparatus for generating and presenting an interface which facilitates a user in making choices that will make that particular user happier with a choice, such as a purchasing decision. The interface may be presented over a distributed network, such as the Internet.

Essentially, the present invention first determines what matters most to a user and then correlates a decision, such as which product to purchase, with that which motivates the user. In some preferred embodiments, steps directed to determining what matters most to a user are determined via “playful” activities. Other embodiments may include traditional question and answer input.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

As presented herein, various embodiments of the present invention will be described, followed by some specific examples of various components that can be utilized to implement the embodiments. The following drawings facilitate the description of some embodiments of the present invention.

FIG. 1 illustrates a block diagram of a prior art method of steps a Purchaser may take in making a purchase.

FIG. 2 illustrates a block diagram of functional modules that may be used to implement embodiments of the present invention.

FIG. 3 illustrates a block diagram of a purchase process that may be used to implement embodiments of the present invention.

FIG. 4 illustrates a block diagram of decision functions that may be included in some implementations of the present invention directed to a purchase decision.

FIG. 5 illustrates a block diagram of decision functions that may be included in some implementations of the present invention directed to a non-purchase decision

FIG. 6 illustrates a block diagram of functionalities that may be used to implement some aspects of the present invention directed to associating emotional attributes with Products.

FIG. 7A-7C illustrate block diagrams of exemplary user interfaces including functionalities that may be included in a user interface used to implement some embodiments of the present invention.

FIG. 8 illustrates apparatus that may be used to implement some embodiments of the present invention.

FIGS. 9A-9B include flow diagrams of method steps that may be experienced by a Purchaser in some implementations of the present invention.

### DETAILED DESCRIPTION OF PREFERRED EMBODIMENTS

The present invention provides automated apparatus with processor and executable software, wherein the software is executable upon demand to assess emotional motivators related to making a purchase. For the purposes of this discussion, a

“Purchaser” or multiple “Purchasers” include one or more individuals, or a succinctly defined organization. The present invention collects or otherwise receives subjective and objective data and associates the subjective and objective data with emotional motivators. The collected data is digitally stored as a motivator profile which may be applied and built upon in order to assist with subsequent purchasing decisions.

Executable software is operative in conjunction with a processor to execute methodologies that match emotional motivators to purchasing decisions. Emotional motivators may be associated with one or more of: an individual actually making a purchase; a person who will receive a purchased good or service; and with a good or service which may be available for purchasing.

Glossary:

As used herein the following terms will have the following associated meaning:
“Buying Context” as used herein means circumstantial data related to a Purchase.
“Cross Channel” as used herein means related to a first Purchase in a first subject area with a second purchase or other decision in a second subject area.
“Emotional Reasons” as used herein Emotional Reasons means subjective emotional motivators that form a basis for satisfaction following completion of a decision, such as, for example, a decision to make a Purchase.
“Engine” as used herein means an apparatus including a processor that executes a software process to receive one or more inputs, process the inputs, and generate an output based upon the inputs.
“Local” as used herein means in a geographic proximity reasonable to travel in order to complete a Purchase based upon objective and subjective aspects of the Purchase.
“Motivator” as used herein shall mean a factor which influences a sense of success in making a decision.
“Product” for the sake of simplicity in this discussion, as used herein a Product shall mean one or more of: a tangible item, machine or device; an intangible conveyance such as knowledge, know how or data stream; and a Service performed (as defined below).
“Purchaser” as used herein shall mean a person that makes or contemplates making a purchase.
“Service” as used herein shall mean an action performed at the request of a Purchaser.

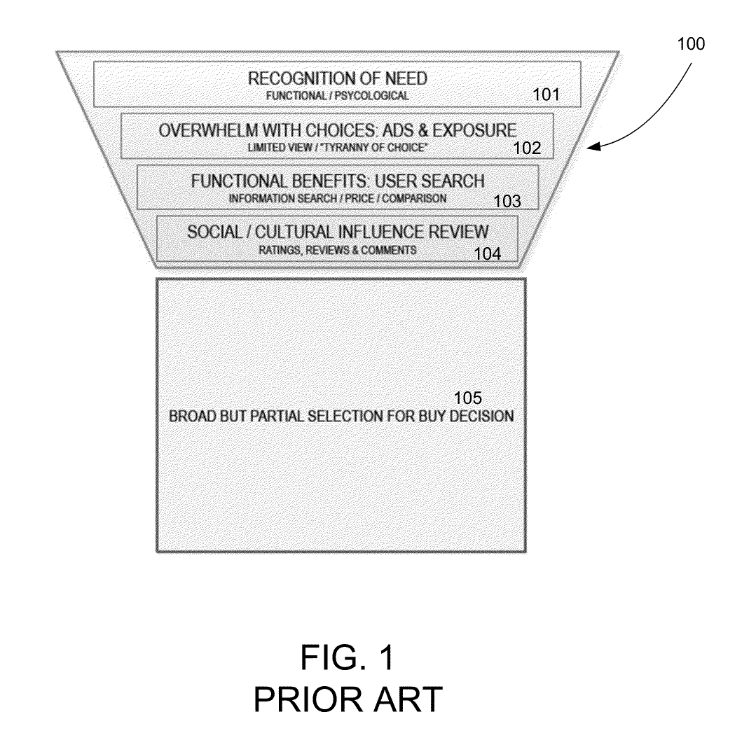

Referring now to FIG. 1, a block diagram illustrates a prior art method for a Purchaser to make a decision to purchase a product or service. At 101, the Purchaser recognizes a need for one or both of: a good and a service. A need may be essentially objective and functional in nature, such as a portion of a defined process, for example a replacement part of a machine, such as an automobile. A need may also be subjective or psychological, such as a need to purchase an item to celebrate an event.

At 102, a Purchaser looking for input may be overwhelmed with choices, advertisements and exposure to media promoting select purchase choices. The view of product and service choices is also limited to those choices that are actively advertised and promoted. At 103, a Purchaser may search functional benefits. The search may reveal information about a product or service, a price and a comparison to other available products. At 104, social and cultural influence may also affect a purchasing decision. The social and cultural influence may include one or more of reviews, ratings and comments descriptive of products.

At 105, the prior art method at best provides a broad amount of information but only partial in regard to a specific purchase event.

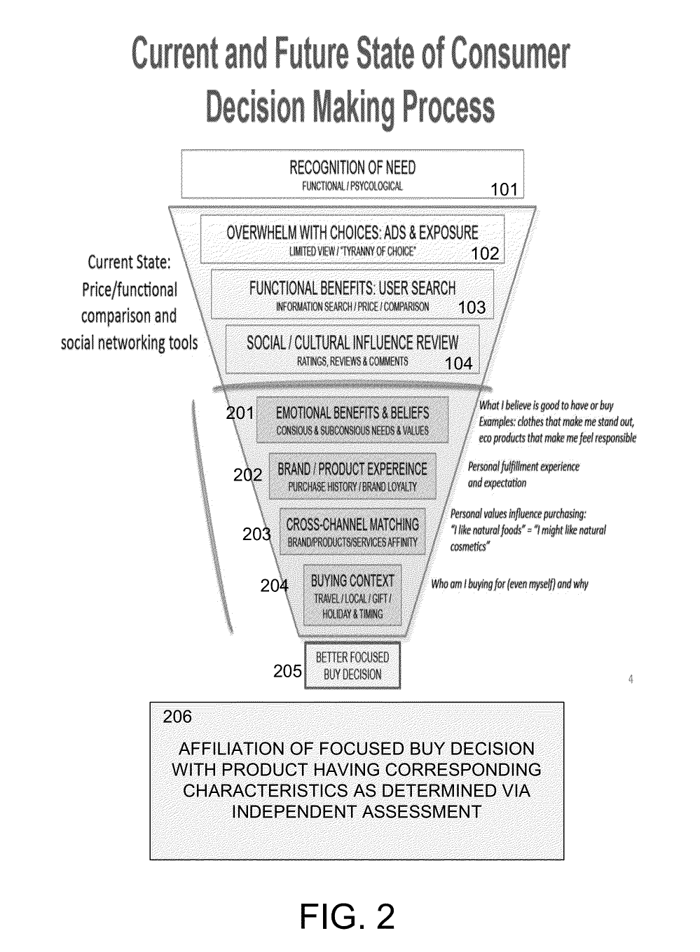

Referring now to FIG. 2, functional steps that may be executed according to the present invention are illustrated. At 201, one or both of emotional benefits and beliefs are assessed.

Emotional benefits and beliefs may be on a conscious or unconscious level and access values inherent in a Purchaser. In some preferred embodiments, discussed more fully below, a Purchaser will provide value related data as input into a computerized apparatus, wherein the data may be processed by a programmable algorithm to correlate the input data with one or more core values useful to make a purchasing decision. Emotional benefits may include, for example, whether a Purchaser believes that it is good to own or to buy Products that make the Purchaser stand out, or whether it is good to own or to buy Products that are ecologically friendly and which make the Purchaser feel responsible.

Another example of an objective need may include a need for a carriage to carry a baby during a jogging activity. A need that is essentially subjective includes a need for a stylish baby carriage that will make the Purchaser appear chic.

At 202, in addition to value based data, the computerized apparatus may include one or both of brand and product experience. A purchase history may also be used, in addition to brand loyalty, or in place of brand loyalty.

At 203, in some embodiments, cross channel matching may be implemented. Cross channel matching includes determining an emotional reason for affinity to a first one or more of: a brand, a Product; and a service. With Cross-Channel matching, one or more Emotional Reasons is stored and made available to be applied to at least a second one or more of: a brand, a Product; and a service. The application of the Emotional Reason to the second one or more of a brand, a Product; and a service, facilitates a recommended choice of purchase of the second brand, Product; or service.

At 204, a buying context may also be considered in making a recommendation of a purchase. A buying context may include, for example, whether the purchase will be: made during travel; from a local vendor (or at least a vendor with a local presence); for a gift for another person; is associated with a holiday; or has specific timing constraints. By way of non-limiting illustration, a buying decision may be for a gift that will be picked up during travel to a particular destination and during particular calendar days. In another illustrative example, a purchase may be for a person supplying emotional Motivators and be for a purchase that will be made local on a same day as purchasing research is conducted.

At 205 a Purchaser is presented with a better focused buying decision. The focus may include a clear representation of who, what, where and when a purchase will be made.

At 206, the present invention correlates a Purchasers Emotional Motivators with a Product having corresponding Motivator characteristics as determined via an independent assessment of the Product (discussed further below).

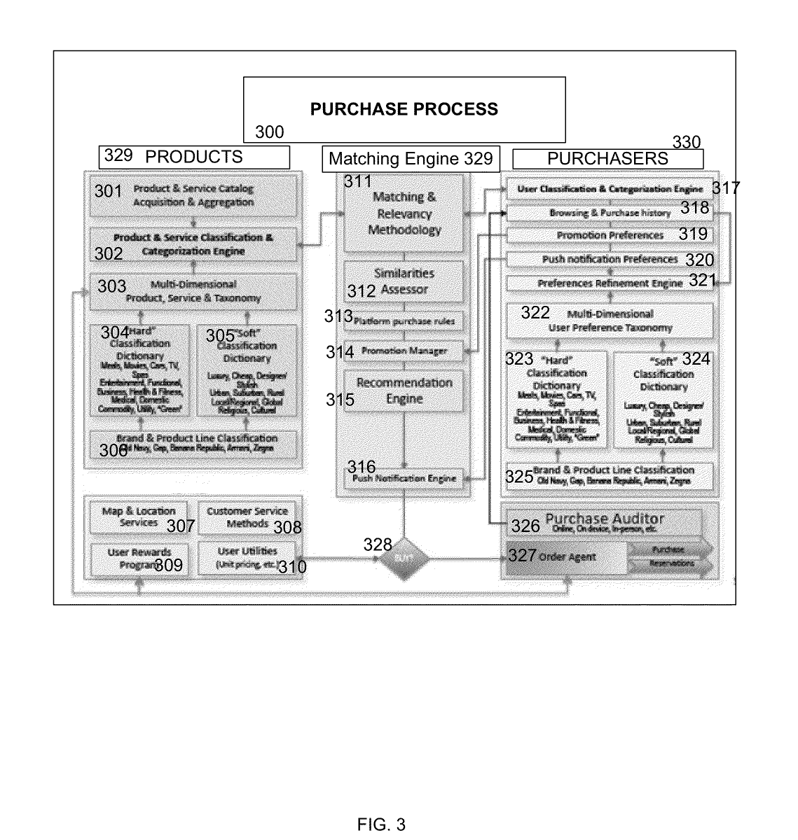

Referring now to FIG. 3, a process is presented according to some embodiments of the present invention. On a high level, the process includes method steps that may be implemented to practice novel aspects of the invention, including, for example, associating Emotional Motivators to Products and Services; associating Emotional Motivators with a Purchaser, and matching one or more Products and Services with a Purchaser. At 301, data is aggregated which is descriptive of one or more Products. The data may include, for example, catalogs, whether physical or virtual with information quantifying aspects of a Product.

At 302, the aggregated data is input into a Product and Service Classification and Categorization Engine. In essence, the engine is a computerized apparatus with programmable code. The programmable code is executable upon demand to parse, sort and link various aspects of the aggregated data according to one or both of predefined taxonomies and relationships and taxonomies and relationships “grown” as a result of data analysis. For example, it is within the scope of the present invention to associate product data with taxonomies and relationships previously encountered by a Product and Service Classification and Categorization Engine or have the engine create new taxonomies and relationships, based upon aggregated Product data received.

At 303, multi-dimensional data may therefore be generated which includes taxonomy tables relevant to a Product and which excludes taxonomy tables not relevant to a Product.

At 304, in some preferred embodiments, a Categorization and Classification Engine will allocate at least some of the aggregated data into a relatively objective “Hard” Classification Dictionary. A Hard classification may include, for example, one or more of: Meals, Movies, Television, Entertainment, Functional Business, Health, Fitness, Spas, Medical, Domestic, Foreign, Commodity, environmentally friendly or “Green” or other relatively bright line test for inclusion or exclusion on an objective basis.

At 305, additionally, some preferred embodiments may include a Categorization and Classification Engine which allocates at least some of the aggregated data into a relatively subjective “Soft” Classification Dictionary. A Soft classification may include, for example, one or more of: luxury, cheap, designer, stylish, urban, suburban, rural, local, regional, global, religious, cultural or other taxonomy or classification which is essentially relative to other taxonomies.

At 306, some exemplary embodiments may also include recognition of a brand associated with a Product. The brand may include a trademark or other designation that associates a Product with a manufacturer or service provider. It is preferable that the brands also be associated with the taxonomies and classifications included in the hard Classification Dictionary and the Soft Classification Dictionary.

At 307-310, additional considerations that may be included in a presentation to a Purchaser of a Product suitable to the Purchaser are illustrated. Additional considerations may include, for example, at 307, a map with an indication of where a Product or Service is available. In some embodiments, a location of a Product or Service may be shown relative to a location of an interested Purchaser. At 308, customer service methods, conditions, and terms may also be a considered taxonomy. At 309, a rewards program along with the conditions and terms of the program may be in included taxonomy. At 310 user utilities that may also be an included Taxonomy.

A matching engine may include automated apparatus including a processor, a digital storage device and executable software stored on the digital storage and executable upon command to match Products which may include goods and services with Purchasers. At 312, a Similarities Assessor may include executable code for associating Emotional Qualifiers with products and Emotional Motivators with users and base similarities of one or both based upon the associations. A Platform Purchase rules module 313 may be used to quantify the logistics of making a purchase for a particular platform on which the resent invention is implemented. For example, an online website may of a first set of Platform Purchase rules 313 and an in store kiosk may include a second set of Platform Purchase rules 313.

In some embodiments, a Promotion Manager 314 may be included for promoting one or more of: a brand, a vendor, a product and a service. Promotion may include interactions with a user via a graphical user interface. A Recommendation Engine 315 is functional to make a Purchase recommendation to a Purchaser based upon the method steps of the present invention. A Push notification engine 316 may be utilized in some embodiments to provide push services to a user, such as a Purchaser of Product related information, such as, for example , availability of a Product, a price of a Product, a promotion of a Product, or other information.

Considering now a Purchaser and taxonomies and data that may be input indicative of the Purchaser's Emotional Motivators, items 318-327 include various aspects of data that may be included by a user categorization and classification engine (sometimes referred to herein as “CC Engine”) 317 practicing the method steps of the present invention.

As defined herein a Motivator may include for example, one or more of: a need for physical safety and emotional security; a need for acceptance (and approval), the need to belong to the group; a sense of self-worth and the need to have others validate one's worth; a need for attention (and the need to attract attention) from others; a need for acknowledgment and approval from those in authority; a need for physical affection and comfort; and a need to control money or other manifestation of material abundance.

At 318, the CC engine 318 may receive and process data indicative of one or both of a browsing history and a purchasing history of a Purchaser. A CC Engines may receive and process data indicative of one or both of: promotion preferences of a Purchaser 319; and push notification preferences of a Purchaser 320. At 321, a Preferences refinement engine may correlate various Purchaser preferences and generate preference trends for a Purchaser. The Purchaser trends may be included in a multi-dimensional Purchaser preference taxonomy or other user preference taxonomy, generated by a computerized device implementing the present invention.

At 322, a multi-dimensional user preference taxonomy may be employed which includes input from a Product hard classifications dictionary 323 and a Product soft classifications dictionary 324. The Product hard classifications dictionary 323 may include, by way of non-limiting example, one or more of: Meals, Movies, Television, Entertainment, Functional Business, Health, Fitness, Spas, Medical, Domestic, Foreign, Commodity, environmentally friendly or “Green” or other relatively bright line test for inclusion or exclusion on an objective basis.

The Product “Soft” Classification Dictionary 324 may generally include by way of non-limiting example, one or more of: luxury, cheap, designer, stylish, urban, suburban, rural, local, regional, global, religious, cultural or other taxonomy or classification which is essentially relative to other taxonomies.

Product and brand classification may also include recognition of a brand associated with a Product. The brand may include, for example, a trademark, service mark, or other designation that associates a Product with a manufacturer or service provider. It is preferable that brands also be associated with taxonomies and classifications included in the hard Classification Dictionary and the Soft Classification Dictionary.

Classification systems may also include brand and Product classifications 325. Product and Brand classification may, for example, include associations of Emotional Qualifiers with Products and/or Brands, wherein the Products and Brands may thereby be associated with Emotional Motivators via the Emotional Qualifiers.

A Purchaser may make a decision to execute a “Buy” action 328 and make a purchase. An order agent 327 may be used to implement a purchase instruction associated with a Buy 328 action. As discussed further below, a Buy action 328 may be communicated to a computerized system via a user interactive device. The user interactive device may be any apparatus that is functional to interface between a human and a computerized system. The user interactive device may therefore include, for example, one or more of: a keyboard, mouse other pointing device, touchscreen, auditory voice command, neural interactive device or other apparatus.

The Order Agent 327 may essentially function as an interface between a user instruction and a purchase or reservation system or module. The Order Agent 327 will provide data to a purchase or reservation system or module sufficient for the purchase or reservation module to execute the Purchase instruction.

In another aspect of the present invention, a Purchase Auditor module 326 may track or audit purchases made by a Purchaser, or group of Purchasers (trending). The Purchase Auditor function may provide analysis of purchasing activity and plot any trends that may be present within data of a Purchaser or group of Purchaser's history. Accordingly, at a first given time period, a Purchaser may be primarily motivated by a first set of Motivators which are based upon a first set of Emotional Reasons. During a second time period, a prevalence of a second set of Emotional Reasons may emerge.

For example, during a first time period, a Purchaser may be primarily motivated by an Emotional Reason of wanting to be stylish or chic. This may correlate, with a period of financial success and significant social interaction. During a second time period, a Purchaser may be primarily motivated by an Emotional Reason of seeking high quality and durability. This period may correlate with a period of financial challenge and focus on raising a family, or other caregiving.

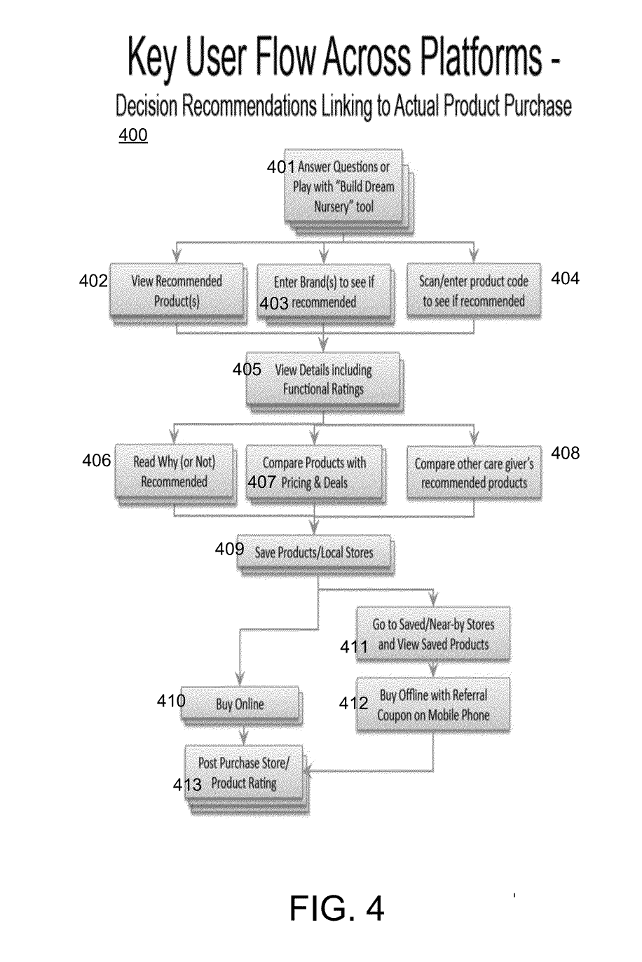

Referring now to FIG. 4, a block diagram illustrates a flow of key user functions across computerized apparatus platforms that may be implemented to facilitate a Purchaser's decision to make a Product purchase. As with other functional modules described herein, the key user functions may be implemented on a computerized device via executable software, executed upon demand. At 401, a Purchaser or other user, may provide input which may be used as input into a Motivator engine to determine primary Emotional Reasons the Purchaser will use to make a Purchase. The input may include, for example, answering questions presented to them about seemingly unrelated choices, or “playing” with an interactive virtual reality scene, such as a “Build a Dream Nursery” tool.

At 402, a computerized system implementing the present invention may allow the Purchaser to view Products which are recommended, based upon input received from the Purchaser. At 403, a Purchaser may also designate a Purchaser preferred brand and the system may indicate if the Purchaser preferred Brand is included in a list of recommended Products.

At 404, a Purchaser may also scan a UPC code or another product identifying code and input the code into the system. The code may be accessed, for example while the Purchaser is shopping in a brick and mortar type store, or at some other time when the Purchaser is observing a Product, such as, for example, when examining a product purchased by a friend. The system may also provide a response indicating whether the scanned item is a recommended item.

At 405, a Purchaser may view details including functional ratings of Products being considered by the Purchaser. The details and ratings may be compiled from multiple sources, including, for example, manufacturer specifications, independent reviews, online blogs, government agencies, ratings entities, or other source.

At 406-408, a Purchaser may receive feedback related to Products of interest to the Purchaser. At 406, feedback may include, for example, why a Product is recommended, or not recommended. At 407 relative prices and purchasing deals for recommended Products may be compared. At 408, Products recommended by other Product users, such as one or more other care givers may also be provided to the Purchaser.

At 409, in some embodiments, a Purchaser may communicate with a store, such as a brick and mortar establishment via a communications network, such as the Internet. Communication with a local store may allow the Purchaser to check inventory of the store for a preferred Product. In addition, in some embodiments, a Purchaser may reserve or save a desired Product at the local store so that the Purchaser may go to the store and review the Product.

At 410, a Purchaser may complete a purchase of a Product online via a virtual storefront, or a virtual exchange. At 411, a Purchaser may physically visit a store and view Products the Purchaser may potentially purchase. At 412 Purchaser may also make a Purchase in the local store. At 413, a Purchaser may provide to a Purchasing system feedback, such as a rating or other indication of the Purchaser's satisfaction with a purchased product or the suitability of a particular product for a purpose.

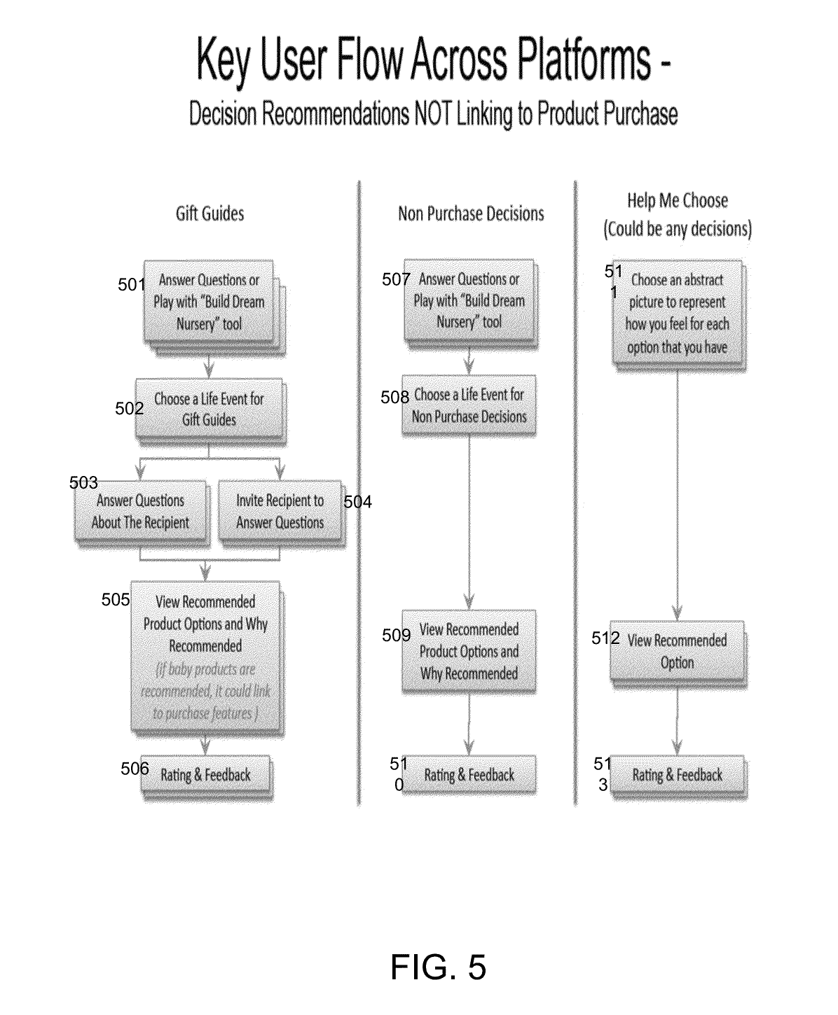

Referring now to FIG. 5, a block diagram illustrates a flow of key user functions across computerized apparatus platforms that may be implemented to facilitate purposes other than a Purchaser's decision to make a Product purchase. At 501-506 steps are illustrated which allow the present invention to be implemented in situations where a Purchaser is making a Purchase for a gift. At 501, a Purchaser may answer interview questions. In some embodiments, answers to questions are gleaned from an interactive activity. The interactive may be presented as a virtual game or a virtual tool. For example, one interactive activity may include a virtual “Build a Dream Nursery” activity. A Purchaser, or in some embodiments, a gift recipient or other relevant person, is encouraged to virtually create a nursery. The present invention, allows a computerized apparatus to track selections made in attributes of the nursery. The attributes chosen may be utilized in lieu of, or in addition to, answers to questions from the Purchaser or other user.

As part of input to an eventual Product recommendation for a given circumstance, at 502, a life event may be chosen for a gift guide. At 503, a Purchaser, or other user may provide answers about a gift recipient. The answers may be submitted to a computerized device via any known user interactive tool. At 504, in addition, in some embodiments, a gift recipient may be invited may be invited to provide answers to questions. For example, a gift recipient may be sent an electronic communication, such as one or more of: an email, a text, and a social media posting. The gift recipient may follow instructions included in the electronic invitation to a website which allows the gift recipient to identify themselves and answer the questions.

At 505, the present invention allows for one or both of the Purchaser (gift giver) and the gift recipient to view information in a human readable form that is descriptive of recommended Products. In some embodiments, the Purchaser and gift recipient are also provided with information descriptive of why one or more particular Products are recommended. At 506 one or both of the Purchaser and the gift recipient are provided with a user interactive interface for providing a rating on a Product and other feedback on one or more of: a Product; the recommendation; and the emotional motivator process for making recommendations.

In another aspect of the present invention, it is noted that an automated system which uses Emotional Reasons and Motivators to assist in decision making is not limited to decisions relating to potential purchases. Almost any decision may be assisted with an understanding and application of knowledge relating to underlying emotions and motivators.

At 507, a user may undertake one or more activities, such as answering questions or participating in a virtual activity. The virtual activity may include, for example, a game or a tool which provides queries to a user for instructions on how to create something online. At 508, in some embodiments, a life event may be associated with a non-purchase decision which will be made by a user. At 509, the user may view recommendations based upon the input received by, or about, the user. The recommendations may include, for example, one or more of: a recommended action step, or course of action; a Product selection; and a collaboration with a particular person or group of people. At 510, a user interactive interface may also be utilized for providing a rating or feedback related to the services and recommendations.

At 511, in a still broader, or more high level, implementation, a user may be asked to choose abstract picture or image which represents how a user “feels” or emotionally responds to one or more options presented to the user. At 512, the user or other party (such as a care taker, friend or employer) may view a recommended option. At 513, one or more of the user and another interested party (such as a care taker, friend or employer) may provide rating and feedback information.

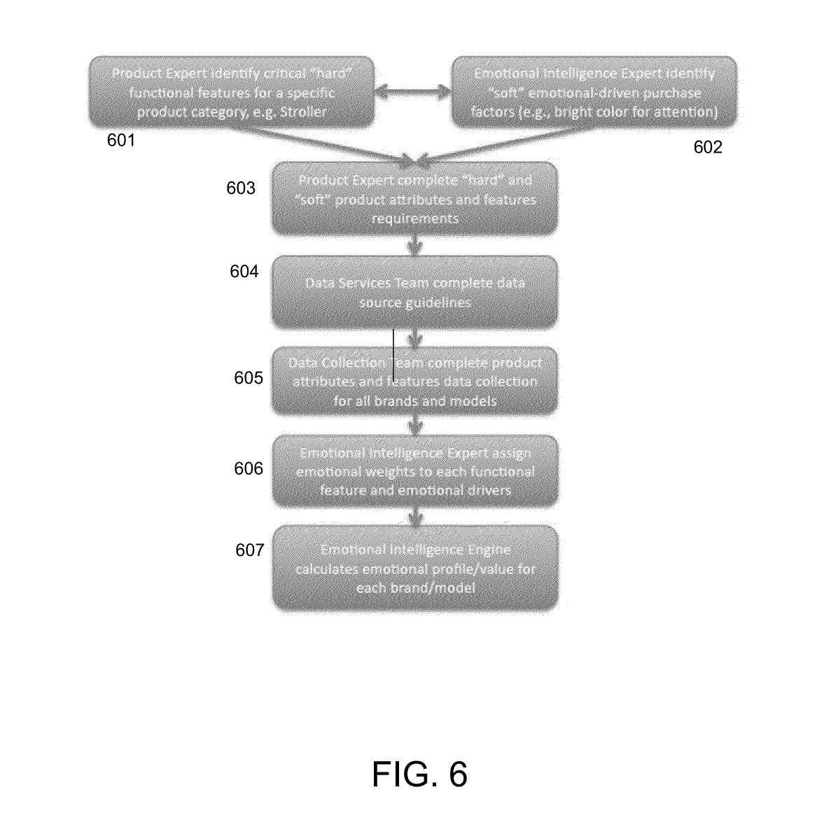

Referring now to FIG. 6, a block diagram illustrates how the present invention utilizes assessments of Products, and associates Products, with both “hard” functional attributes and “soft” emotional attributes.

At 601, the present invention receives input from one or more Product Experts which identify critical “hard” functional features for specific products category, such as, for example a baby stroller, an electronic device, a backpack, or almost any other Product. A hard functional feature may include for example, almost any empirical data, and may therefore include, for example, specifications, power ratings, physical dimensions, or other verifiable fact.

At 602, the present Emotional Intelligence Expert identifies one or more “soft” emotional-driven purchase factors. For example, a Product with a bright color may be associated with an emotional need for attention, a Product with rugged features and durability may be associated with a need to appear masculine. The soft features may be obtained from a database of available features and how those features may translate into, and evoke human emotions.

At 603, a Product Expert may complete a combination of hard and soft product attributes and feature requirements for a Product desired by a Purchaser or other user. At 604, a data services team may provide data source guidelines for a Product. The data source guidelines may include the data fields and definitions for datum that will be compiled for particular product groups. The data source guidelines will serve as an indication of which data fields should be collected for a particular Product, or Product group.

At 605, a data collection team may be tasked with providing the data fields specified by the Product Experts. The data collection may aggregate an input data values into a database which is made available to various engines to facilitate Product selection based upon Motivators and Emotional reasoning.

At 606, in some preferred embodiments, emotional weights are assigned to at least some, if not all of the functional features and emotional drivers. One natural choice is to have one or more emotional intelligence experts assign weights to functional features, and weights to emotional drivers. A weight may include, for example, an alpha numerical value that is associated with a relative scaled value. Other ratings or weights are also within the scope of the present invention, such as, for example, a color coded value.

At 607, in some preferred embodiments, an Emotional Intelligence Engine calculates a value which is associated with an emotional profile for a Product. The value associated with an emotional profile is preferably stored in a data structure which allows the value to be retrieved upon demand. The value may include multiple dimensions. For example, the value may include a scaled indication of an appearance of fiscal status, such as, for example, the brand name Louis Vitton™ may represent wealth, another emotional value may provide an indication of durability, another emotional value may provide an indication of subtleness or loudness. Other emotional values may be included within the scope of the invention, wherein any emotional value that may be influential in a Purchase decision or other decision at hand may be included.

### Apparatus

The teachings of the present invention may be implemented with any apparatus capable of embodying the innovative concepts described herein. Image presentation can be accomplished via any multimedia type interface. Embodiments can therefore include a PC, handheld, game controller; PDA, cellular device, HDTV or other multimedia device with user interactive controls, including, in some embodiments, voice activated interactive controls.

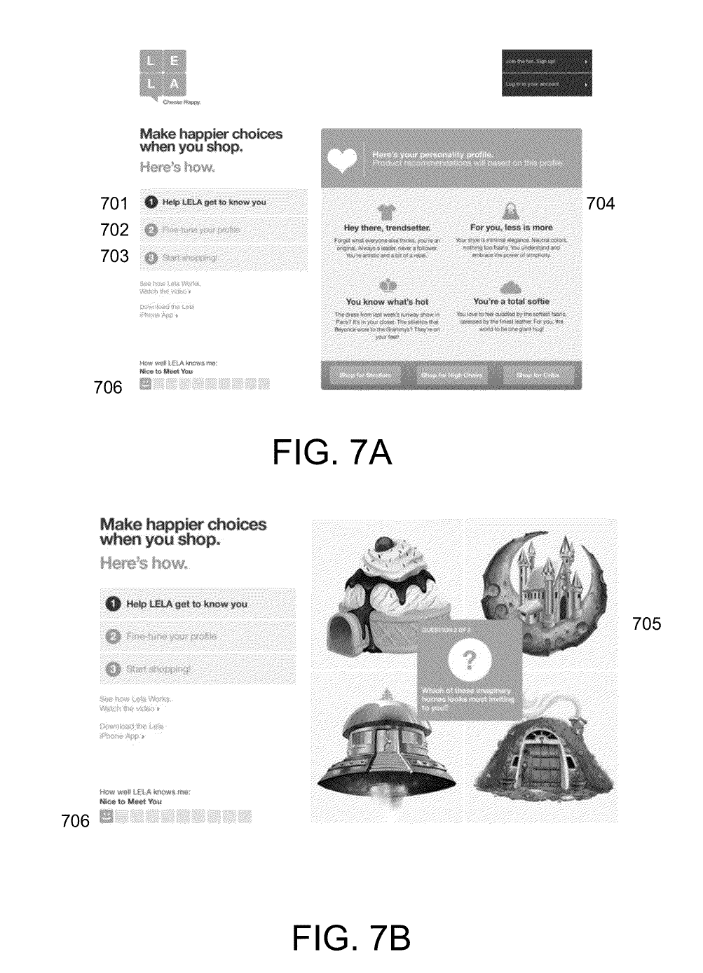

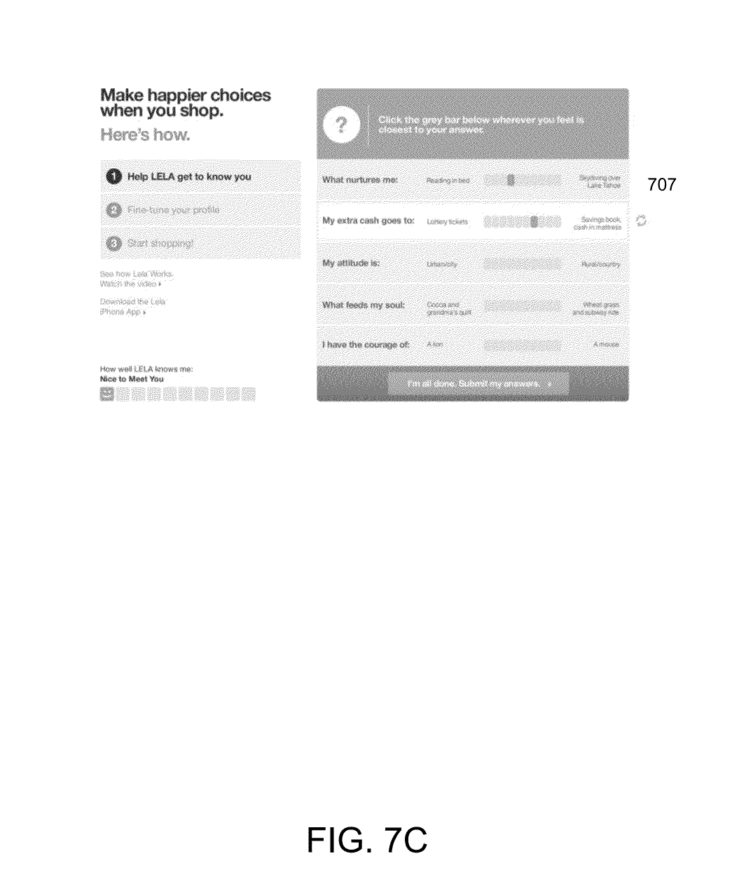

Referring now to FIG. 7A, an exemplary user interactive interface is illustrated. The interface includes multiple user interactive areas which may receive input from a user and provide one or both of human readable content or human recognizable images.

Interactive areas may include, by way of non-limiting example, one or more of: a) a user interactive area on a screen that prompts a user of “Help LELA get to know you” 701; b) Fine tune your Profile 702; c) Start Shopping 703.

The Help LELA get to know you interactive area 701 is illustrative of a service such as the LELA™ service. This area 701 may be selected by a user to lead the user through a series of interactive queries designed to educate a LELA software engine about a user. For example, in some preferred embodiments, images may be presented to a user wherein the user is prompted to select one of multiple images in response to one or more questions. In addition, questions may be presented in sentence format and also be used to help LELA “know” the user. In some embodiments, the LELA questions are designed to have the user provide answers that are indicative of one or more emotional motivators that influence the user.

At 702 the user may also be provided with an area that allows the user to “fine tune” or otherwise modify the user profile, including emotional motivators. In some embodiments, a user may use interactive user devices such as icons and prompts to request a new set of images related to a question or to request one or more new questions.

At 703, a user may also choose to begin shopping with assistance of a LELA™ program that relates one or more Products with emotional motivators associated with the user.

At 704, another user interactive area may include an area that provides feedback indicating what Emotional Motivators are associated with the user. At 706, an indicator of how well a user is being serviced by a provider of an interactive interface.

Referring now to FIG. 7B, additional user interactive areas may also include an area that provides an indicator of how well LELA™ knows the user. Essentially, how well LELA™ knows a user may be based upon, for example, one or more of: a number of questions answered by the user a number of images chosen by the user; a number of transactions executed by the user, a browsing history, or other forms of input.

At 705, a group of exemplary images is presented, wherein each image is indicative of one or more emotional motivators. Selection of an image by a user may provide input to LELA™ Emotional Motivators that may influence a user. At 7706,

Referring now to FIG. 7C, in some preferred embodiments, a user interface that receives input indicating emotional motivators of a Purchaser or other user may include questions that have two questions on a scale, wherein the Purchaser provides a scaled answer along a continuum formed between the two answers. For example, a Purchase may be queried as to what nurtures the Purchaser. Two answers, such as 1) “reading in bed” and 2) “skydiving over Lake Tahoe”. A scale between the two phrases may have a number of positions with some positions closer to the first answer and some positions closer to the second answer and a position equally distant from the first answer and the second answer. A position chosen provides a weighted indication of an answer closest to how a Purchaser feels. As illustrated, multiple questions and weighted answers along respective scales may be provided.

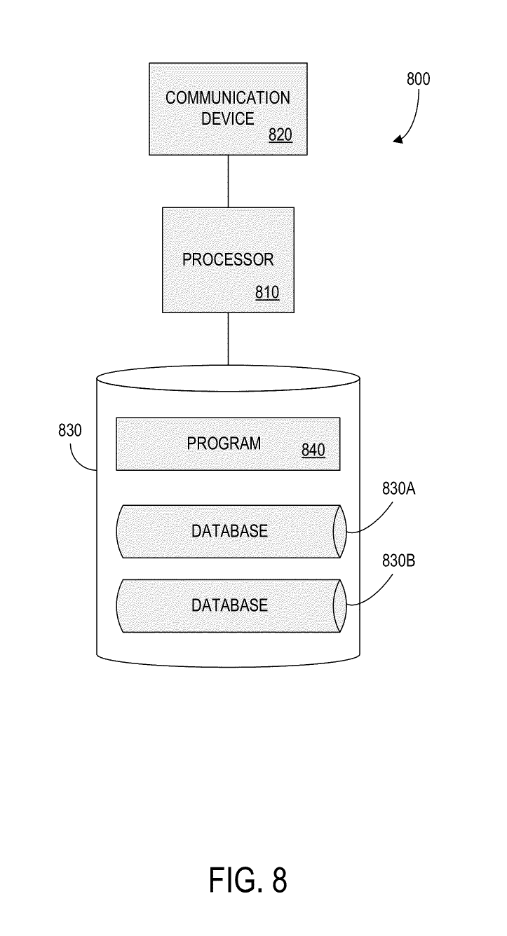

Referring now to FIG. 8, an illustration is provided with a controller 800 that may be embodied in one or more of communications accessible devices and utilized to implement some embodiments of the present invention. Communications accessible devices may include, by way of example, a hand held device such as a cellular phone, a pad device, a personal computer, a server, a personal digital assistant, an electronic reader device or other programmable device.

The controller 800 comprises a processor unit 810, which may include one or more processors, coupled to a communication device 820 configured to communicate via a communication network, such as the Internet, or another cellular based network such as a 3G or 4G network (not shown in FIG. 8). The communication device 820 may be used to communicate with a digital communications network, such as, for example, the Internet available via the Internet Protocol, or a cellular network such as 3G or 4G.

The processor 810 is also in communication with a storage device 830. The storage device 830 may comprise any appropriate information storage device, including combinations of electronic storage devices, such as, for example, one or more of: hard disk drives, optical storage devices, and semiconductor memory devices such as Random Access Memory (RAM) devices and Read Only Memory (ROM) devices.

The storage device 830 can store a program 840 for controlling the processor 810. The processor 810 performs instructions of the program 840, and thereby operates in accordance with the present invention. The processor 810 may also cause the communication device 820 to transmit information, including, in some instances, control commands to operate apparatus to implement the processes described above. The storage device 830 can additionally store related data in a database 830A and database 830B, as needed.

Methods

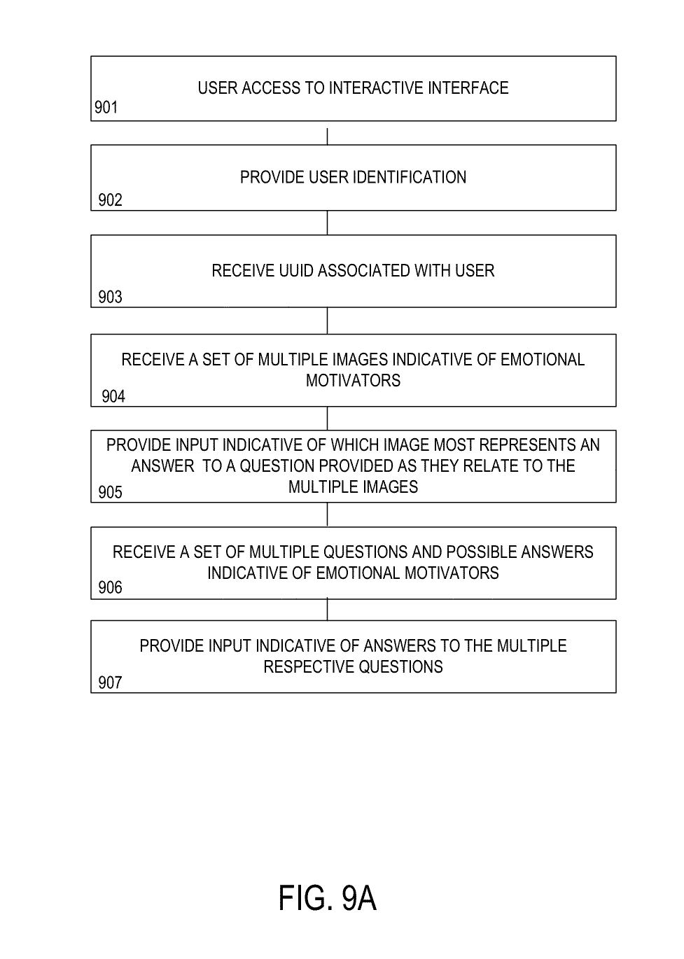

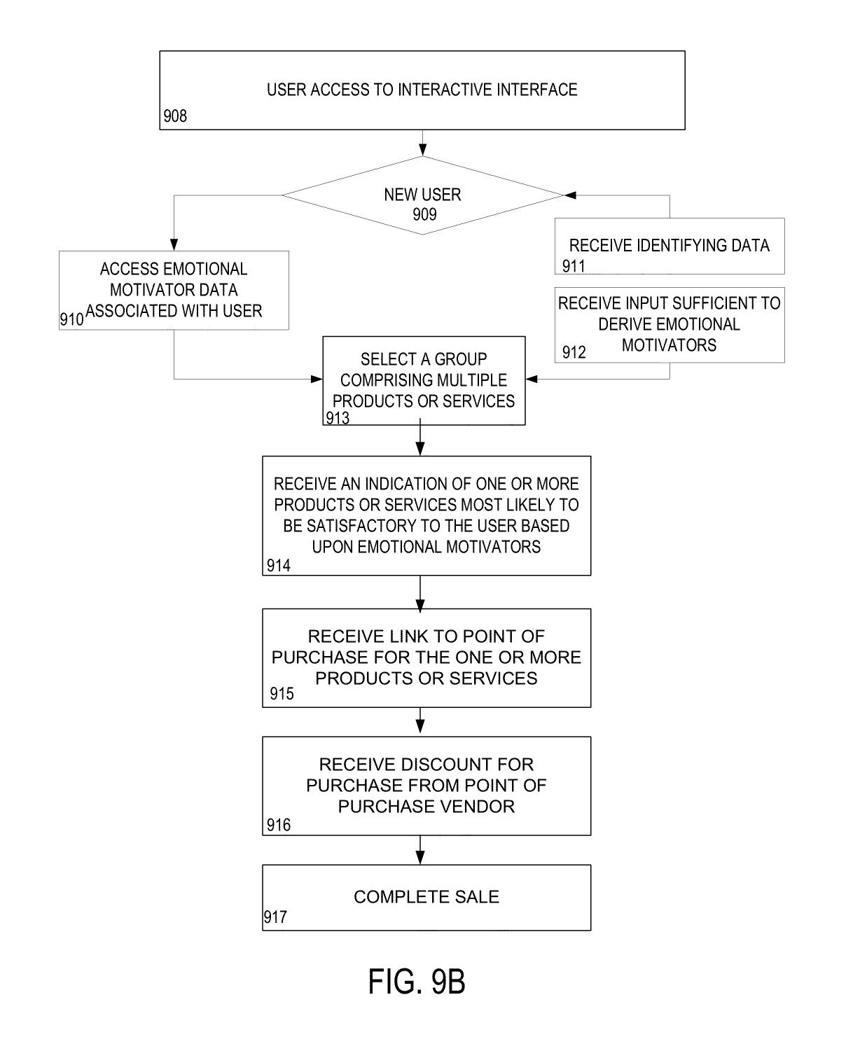

Referring now to FIG. 9A, a flow chart with method steps that may be incorporated into some embodiments of the present invention. The method steps are presented as exemplary and are not required to be executed in a particular order.

At 901, a user, such as a Purchase who is contemplating a purchase for either themselves or for a beneficiary, may access an interactive interface, some preferred embodiments may include access via the Internet or via a mobile phone network, such as, for example, a 3G or 4G network or other cellular or WiFi network.

At 902, the user may provide user identification and at 903 the user may receive a unique identifier, such as, for example in some embodiments, a UUID (universally unique identifier).

At 904, the user may receive a set of multiple images, wherein each respective image is indicative of one or more emotional motivators. At 905, the user may provide input indicative of which image or images represent an answer to a question provided to the user related to the multiple images.

At 906, the user may also receive one or more questions relating to emotional motivators. Questions may be presented, for example via written text or via audio. At 907, the user may provide input indicative of an answer to the multiple respective questions. Answers to the multiple questions will be used to associate emotional motivators with the user.

Referring now to FIG. 9B, additional method steps that may be used to implement some embodiments of the present invention. At 908, a user may access an interactive interface, some preferred embodiments may include access via the Internet or via a mobile phone network, such as, for example, a 3G or 4G network or other cellular or WiFi network.

At 909, the user may indicate whether the user is a new user or already has a profile including emotional motivator data associated with the user. If the user already provided data indicative of the user's emotional motivators, at 910 the system will access the emotional motivator data associated with the user.

If the user is a new user, or for some other reason does not have data associated with the user, at 911, the system may receive user identifying data and at 912 receive input sufficient to associate or otherwise derive emotional motivator motivators with the user.

At 913, the user may select a group including multiple products or services and at 914 the user may receive an indication of one or more Products or Services most likely to be satisfactory to the user based upon the emotional motivators associated with the user.

At 915, the user will receive a link to a point of purchase for the one or more Products and/or Services indicated to be satisfactory to the user. In some embodiments, the point of purchase may be a virtual storefront, or other electronic marketplace or webpage, wherein the Purchaser may complete a purchase of a Product via a linked Internet site. In other embodiments, the point of purchase may include a brick and mortar store. A brick and mortar store may include one or more stores determined to be geographically accessible to the user, such as a brick and mortar store in close proximity to the user, such that the user may reasonably travel to the store and make a purchase. A reasonable travel may be based upon a time and cost of travel in relation to a pecuniary value associated with a related Product purchase.

At 916, in order to entice user to become a Purchaser, the user may receive a discount for Purchase from a point of purchase vendor. The discount may be embodied in the form of a coupon, a rebate, a code, a specific link, or other artifact for conveying discount information. In some preferred embodiments, the discount includes a reference to a provider of a service that processes the emotional motivator data. At 917, the user and/or the vendor may complete the sale.

### CONCLUSION

A number of embodiments of the present invention have been described. Nevertheless, it will be understood that various modifications may be made without departing from the spirit and scope of the invention. For example, various methods or equipment may be used to implement the process steps described herein or to create a device according to the inventive concepts provided above and further described in the claims. In addition, various integration of components, as well as software and firmware may be implemented. Accordingly, other embodiments are within the scope of the following claims.

What is claimed is:

1. A computerized apparatus for receiving advice related to a Purchase decision, the apparatus comprising:
a communications network access device for accessing a server in logical communication with a communications network; and
executable software stored on the communications network access device and executable on demand, the software operative with the communications network access device to cause the network access device to:
receive a Purchaser interface for making selections which indicate emotional motivators of the Purchaser;
transmit one or more selected indications of emotional motivators;
receive a Purchaser interface for inputting a selection of a type of product or service the Purchaser is interested in; and
receive a display descriptive of one or more Products determined to be satisfactory to the Purchaser based upon emotional motivators associated with the Purchaser, wherein the emotional motivators associated with the Purchaser are determined based upon the transmitted indications of emotional motivators.

2. The apparatus of claim 1 wherein the software is additionally operative to receive a discount artifact entitling the Purchaser to a discounted price for the one or more Products determined to be satisfactory to the Purchaser.

3. The apparatus of claim 2 wherein the software is additionally operative to receive a link to a virtual point of purchase for the one or more of the Products determined to be satisfactory to the Purchaser based upon emotional motivators associated with the Purchaser.

4. The apparatus of claim 2 wherein the software is additionally operative to receive a link to a geographically local point of purchase for one or more of the Products determined to be satisfactory to the Purchaser based upon emotional motivators associated with the Purchaser.

5. The apparatus of claim 1 wherein the software is additionally operative to receive a Purchaser interactive display comprising a description of emotional motivators associated with the Purchaser.

6. The apparatus of claim 1 wherein the software is additionally operative to display a history of Purchase transactions completed by the Purchaser.

7. The apparatus of claim 1 wherein the software is additionally operative to display a history of inputs comprising indications of emotional motivators associated with the Purchaser.

8. The apparatus of claim 1 wherein the software is additionally operative to display an indication of how well a software engine designed to quantify emotional motivators is aware of Purchaser preferences based upon emotional motivators.

9. The apparatus of claim 1 wherein the software is additionally operative to indicate to the Purchaser which emotional motivators are associated with the Purchaser.

10. The apparatus of claim 1 wherein the software is additionally operative to indicate to the Purchaser which emotional motivators are associated with a Product chosen by the Purchaser.

11. A computerized apparatus for providing advice related to a Purchase decision, the apparatus comprising:
a computer server in logical communication with a communications network; and
executable software stored on the computer server and executable on demand, the software operative with the communications network access device to cause the server to:
transmit a Purchaser interface for making selections which indicate emotional motivators of the Purchaser;
receive one or more indications of emotional motivators to be associated with a Purchaser;
transmit a Purchaser interface for receiving a selection of a type of Product or Service the Purchaser is interested in;
associate one or more Products or Services with the Purchaser based upon the received indications of emotional motivators; and
transmit a display descriptive of one or more Products determined to be satisfactory to the Purchaser based upon emotional motivators associated with the Purchaser, wherein the emotional motivators associated with the Purchaser are determined based upon the transmitted indications of emotional motivators.

12. The apparatus of claim 11 wherein the software is additionally operative to transmit a discount artifact entitling the Purchaser to a discounted price for the one or more Products determined to be satisfactory to the Purchaser.

13. The apparatus of claim 12 wherein the software is additionally operative to transmit a link to a virtual point of purchase for the one or more of the Products determined to be satisfactory to the Purchaser based upon emotional motivators associated with the Purchaser.

14. The apparatus of claim 12 wherein the software is additionally operative to receive a link to a geographically local point of purchase for one or more of the Products determined to be satisfactory to the Purchaser based upon emotional motivators associated with the Purchaser.

15. The apparatus of claim 11 wherein the software is additionally operative to transmit a Purchaser interactive display comprising a description of emotional motivators associated with the Purchaser.

16. The apparatus of claim 11 wherein the software is additionally operative to transmit a history of Purchase transactions completed by the Purchaser.

17. The apparatus of claim 11 wherein the software is additionally operative to transmit a history of inputs comprising indications of emotional motivators associated with the Purchaser.

18. The apparatus of claim 11 wherein the software is additionally operative to transmit an indication of how well a software engine designed to quantify emotional motivators is aware of Purchaser preferences based upon emotional motivators.

19. The apparatus of claim 11 wherein the software is additionally operative to transmit an indication to the Purchaser specifying which emotional motivators are associated with the Purchaser.

20. The apparatus of claim 11 wherein the software is additionally operative to indicate to the Purchaser which emotional motivators are associated with a Product chosen by the Purchaser.
